(19) United States
(12) Patent Application Publication
(10) Pub. No.: US 2015/0047770 A1
(43) Pub. Date: Feb. 19, 2015

(54) TIRE-FORMING MACHINE CONNECTOR APPARATUS AND CONNECTOR HANDLING METHOD THEREFOR

(71) Applicant: MESNAC CO., LTD., Shandong (CN)

(72) Inventors: Jiguo Cheng, Shandong (CN); Fude Zhou, Shandong (CN); Rui Shao, Shandong (CN); Chunhai Dai, Shandong (CN)

(73) Assignee: MESNAC CO., LTD., Shandong (CN)

(21) Appl. No.: 14/354,970

(22) PCT Filed: Dec. 7, 2012
(86) PCT No.: PCT/CN2012/086143

§ 371 Date: Sep. 12, 2014

(30) Foreign Application Priority Data
Dec. 7, 2011 (CN) 201110402783.2

(51) Int. Cl. B29D 30/30; B29D 30/06

(52) U.S. Cl. CPC B29D 30/30; B29D 30/0681; B29D 2030/0682; B29K 2105/253
USPC 156/123; 156/421

(57) ABSTRACT

The joint device for a tire forming machine comprises a joint device connection frame, composite part laminating device, and cord fabric stitching device, wherein the joint device connection frame axially slides along a portal frame through a connection frame drive device, and is located above the vertical direction of a tire body drum; the composite part laminating device is carried on a joint device connection frame through a composite part frame body; the composite part laminating device comprises an axial laminating drive device and a vertical laminating drive device for controlling and driving a compression roller component located on a composite workstation on the tire body drum; the cord fabric stitching device is carried on the joint device connection frame through a main stitching frame; the cord fabric stitching device comprises an axial stitching drive device and a vertical stitching drive device for controlling and driving a stitching wheel component located on a stitching workstation on the tire body drum.

This application claims priority under 35 U.S.C. §119 to Application No. PCT/CN2012/086143 filed Dec. 7, 2012, which claims priority to Chinese Patent Application No. 2011-10402783.2, filed Dec. 7, 2011, both of which are incorporated herein in their entirety.

### FIELD OF THE INVENTION

The invention relates to a joint device for a tire forming machine and a joint treatment method thereof, and particularly to a composite part laminating device and a cord fabric stitching device that are integrally arranged on a same connection frame, wherein laminating and stitching execution mechanisms are conveyed to the related operation workstations by the connection frame through a top conveyer.

### BACKGROUND OF THE INVENTION

Generally, present rubber tires are used on many kinds of vehicles, and the manufacturing of rubber tires involves machine processes such as laminating a steel wire tire bead, a tire body component and a belted layer-tread component into tires.

Preparation of the tire body component is usually finished on the tire body drum, and then the tire body component is conveyed to a forming drum that is part of the manufacturing tire billet. In preparing the tire body component, an overlapping part between an inside liner and glue at two tire sides needs to be laminated by a laminating device. This will extrude and discharge air bubbles. Subsequently, a stitching operation needs to be carried out on the joint of the attached tire body cord fabric by using a stitching device.

At present, tire forming machines have a separately installed laminating device and stitching device for successively carrying out the above process. The two devices are respectively controlled through respective execution mechanisms, so as to independently finish the operation on the tire body drum. This procedure results in defects and disadvantages discussed below.

The laminating device and the stitching device are independent mechanisms that need to be respectively installed at the positions near the tire body drum, and also need large installation space and travel distance. Thus, simplification and miniaturization design of the overall structure of the forming machine are not possible.

The laminating device and the stitching device are controlled by respective execution mechanisms, so that two sets of locating devices need to be arranged to respectively calibrate and center operation workstations on the tire body drum. Thus, control of equipment cost is not facilitated, and the centering accuracy is jeopardized.

The laminating device and the stitching device universally carry out movement between different workstations by virtue of a ground guide rail. Therefore, a potential safety hazard is caused by collision of an operator and equipment because a large surface installation area is occupied, and corresponding demands on the ground flatness are high. Thus, improvement of the operation accuracy is not facilitated.

The existing joint device of the tire forming device needs separate installation and separate control modes. Thus, operation components are transported and located by virtue of the ground guide rail, resulting in the defects and disadvantages in the existing procedure. Advances in tire billet production technologies is determined by the differences of the structures and control modes of these components, and the requirements on the tire forming quality and the production efficiency cannot be completely achieved.

Accordingly, the present invention discloses a joint device for a tire forming machine and a joint treatment method thereof, and aims at solving the defects of the prior art. A composite part laminating device and a cord fabric stitching device are integrally arranged on a same connection frame, and related execution mechanisms are conveyed to the appointed workstations on a tire body drum through a top conveyer, so that the quantity of components and required installation space are simplified. A drive mechanism is placed above ground, so as to clear the related ground conveying components, facilitate control and auxiliary operations of an operator in the tire billet manufacturing process, and avoid an accident caused by collision of the operator and the equipment.

The present invention further discloses a composite part laminating device and the cord fabric stitching device that carry out calibrating and centering on the basis of the same locating device by virtue of the same connection frame. Thus, the centering accuracy is high in comparison with the operation workstation of the tire body drum.

Another object of the present invention, is to have two operation flows of laminating of the composite part and stitching of the tire body cord fabric integrated, therefore shortening of the operation time and improving the production efficiency of the single tire billet.

Additional features and advantages of the invention will be set forth in the description that follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the invention, as embodied and broadly described, the present invention provides a joint device for a tire forming machine, comprising a compression roller component configured to laminate an inside liner and tire sides for forming a tire billet, and a stitching wheel component configured joint stitch cord fabric, the joint device comprising: a joint device connection frame connected to a top portal frame in a sliding manner, configured to axially slide along the portal frame through a connection frame drive device, and located above the vertical direction of a tire body drum; a composite part laminating device carried on the joint device connection frame through a composite part frame body, comprising an axial laminating drive device and a vertical laminating drive device configured to control and drive the compression roller component to a composite workstation on the tire body; and a cord fabric stitching device carried on the joint device connection frame through a main stitching bracket, comprising an axial stitching drive device and a vertical stitching drive device configured to control and drive a stitching wheel component to a stitching workstation on the tire body drum.

In another embodiment, the joint device for the tire forming machine and, specifically the joint device connection frame comprises a main bracket and a lateral connection frame, the main bracket arranged in parallel to the portal frame; the lateral connection frame being connected to the main bracket and configured to carry the composite part laminating device and the cord fabric stitching device; the connection frame drive device comprises a first cylinder arranged between the joint device connection frame and the portal frame, configured to axially push the joint device connection frame along the portal frame; and a plurality of slide frames connected to two sides of the main bracket, slide blocks arranged at the inner sides of the slide frames are meshed with slide rails on the portal frame.

In yet another embodiment, the joint device for the tire forming machine further comprises a second cylinder, on the side of the main bracket, configured to connect and longitudinally push the lateral connection frame in a reciprocating manner.

Another embodiment of the joint device for the tire forming machine comprises two pairs of hydraulic buffer, at the side of the main bracket, configured to limit the longitudinal reciprocating motion distance of the lateral connection frame.

In another embodiment, the joint device for the tire forming machine comprises a composite part frame body of the composite part laminating device is arranged on the lateral connection frame of the joint device connection frame; and wherein an axial laminating drive device comprises a first motor arranged on the composite part frame body; an output shaft of the first motor is connected with a first synchronous pulley on a first synchronous belt, which is transversely arranged along the composite part frame body, the first synchronous belt also being connected with a connection plate for installing the compression roller component; and the vertical laminating drive device comprises a pair of third cylinders arranged between the lateral connection frame and the composite part frame body and configured to push and pull the composite part frame body in a reciprocating manner along a vertical direction.

In another embodiment, the joint device for the tire forming machine comprises the main stitching bracket of the cord fabric stitching device arranged on the lateral connection frame of the joint device connection frame: the axial stitching drive device comprises a second motor arranged on the main stitching bracket; the output shaft of the second motor is connected with a second synchronous pulley sleeved on a second synchronous belt, the second synchronous belt connected with a third synchronous pulley on a screw, which is transversely arranged along the main stitching bracket; the stitching wheel component arranged on a pair of movable brackets, the movable brackets connected with a nut sleeved on the screw; and the vertical stitching drive device comprises a pair of fourth cylinders, arranged on the movable brackets and connected with the stitching wheel component.

Another embodiment of the present invention is a joint treatment method achieved by the joint device for the tire forming machine comprising: laminating, by the compression roller component, on the inside liner and the tire side rubber attached to the tire body drum; joint stitching, by the stitching wheel component, on the subsequently attached tire body cord fabric; wherein the joint device connection frame connected to the top portal frame in a sliding manner, axially slides along the portal frame and is located above the vertical direction of the tire body drum; the composite part laminating device with the compression roller component is carried on the joint device connection frame, the compression roller component is located on the composite workstation on the tire body drum along the axial direction and the vertical direction of the joint device connection frame; and the cord fabric stitching device with the stitching wheel component is carried on the joint device connection frame, and the stitching wheel component is located on the stitching workstation on the tire body drum along the axial direction and the vertical direction of the joint device connection frame.

In another embodiment, the joint treatment method for the tire forming machine comprises a pair of second cylinders for longitudinally pushing the lateral connection frame in the reciprocating manner arranged at a side part of the main bracket of the joint device connection frame; and the composite part laminating device and the cord fabric stitching device are alternatively located on the vertical center line of the tire body drum.

In yet another embodiment, the joint treatment method for the tire forming machine comprises two pairs of hydraulic buffers arranged at a side part of the main bracket of the joint device connection frame to limit the displacement distances of the composite part laminating device and the cord fabric stitching device along the longitudinal direction.

Another embodiment of the joint treatment method for the tire forming machine comprises sliding, by the joint device connection frame, along the axial direction of the portal frame, wherein the joint device connection frame is located above a vertical direction of the tire body drum and the composite part laminating device is arranged on the vertical center line of the tire body drum; descending, by the compression roller component, to the composite workstation at one side end of the tire body drum, along the vertical direction, and moving to the other side end of the tire body drum along the axial direction, so as to finish the laminating operation on the inside liner and the tire side rubber; ascending, by the compression roller component, to the initial position along the vertical direction; pushing, by the second cylinder, the lateral connection frame to longitudinally move, so as to locate the cord fabric stitching device on the vertical center line of the tire body drum; descending, by the stitching wheel component to the stitching workstation of the tire body drum along the vertical direction, and moving in a reciprocating manner along the axial direction of the tire body drum, so as to finish the joint stitching operation on the tire body cord fabric; ascending, by the stitching wheel component to an initial position along the vertical direction; reversely sliding, by the joint device connection frame to the initial position along the axial direction of the top portal frame; and reversely pushing, by the second cylinder to the lateral connection frame along the longitudinal direction, so as to enable the composite part laminating device and the cord fabric stitching device to slide to the initial positions.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the Drawings:

FIG. 1 is a structure diagram of the main machine part of the forming machine according to an embodiment of the present invention.

FIG. 2 is the overall structure diagram of the joint device according to an embodiment of the present invention.

FIG. 3 is a lateral diagram of the joint device connection frame according to an embodiment of the present invention.

FIG. 4 is a structure diagram of the composite part laminating device according to an embodiment of the present invention.

FIG. 5 is a bent structure diagram of FIG. 4.

FIG. 6 is a structure diagram of the cord fabric stitching device according to an embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

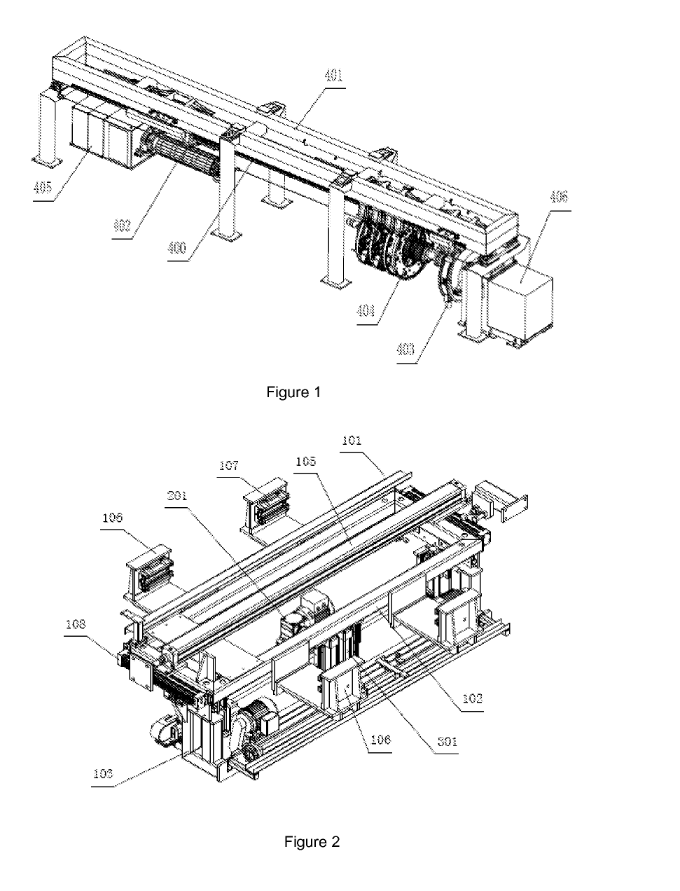

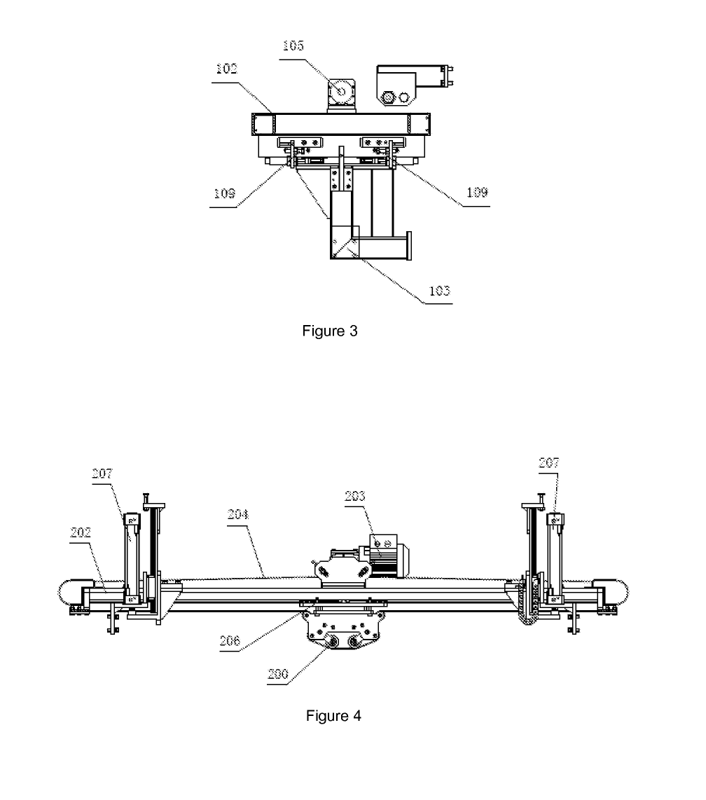

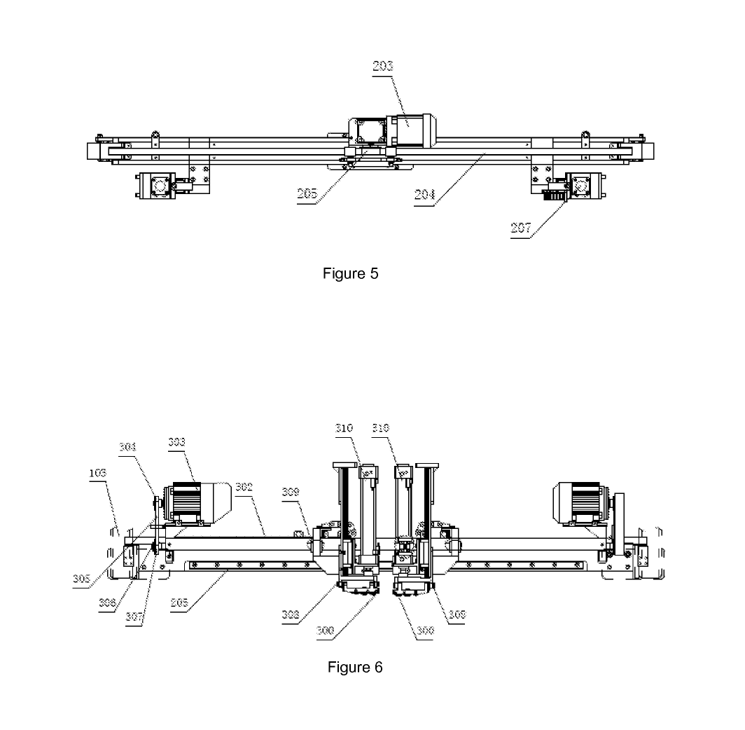

As shown in the FIGS. 1 to 6, the present invention comprises a joint device connection frame 101, a main bracket 102, a lateral connection frame 103, first cylinders 105, slide frames 106, slide blocks 107, second cylinders 108, hydraulic buffers 109, a compression roller component 200, a composite part laminating device 201, a composite part frame body 202, a first motor 203, a first synchronous belt 204, a first synchronous pulley 205, a connection plate 206, third cylinders 207, a stitching wheel component 300, a cord fabric stitching device 301, a main stitching bracket 302, a second motor 303, a second synchronous pulley 304, a second synchronous belt 305, a screw 306, a third synchronous pulley 307, movable brackets 308, a nut 309, fourth cylinders 310, slide rails 400, a portal frame 401, a tire body drum 402, a belted layer drum 403, a forming drum 404, a tire body drum drive unit 405, and a forming drum drive unit 406.

FIG. 1 is a structure diagram of the tire forming machine. As shown, the tire forming machine comprises a tire body drum 402, a belted layer drum 403 and a forming drum 404, which are arranged on the same horizontal axis.

A feeding system of the tire body drum 402 comprises a main feeding frame and a pad rubber feeding frame (not shown in the figure) arranged at two sides. The drive unit of the tire body drum 402 is a tire body drum drive unit 405, which is coaxially arranged at the outer side of the tire body drum 402.

The forming drum 404 and the belted layer drum 403 are carried by the same forming drum drive unit 406, arranged at the outer side of the belted layer drum 403.

The portal frame 401 for conveying material is arranged above the vertical direction of the main machine of the overall forming machine. A pair of slide rails 400 are arranged at two sides of the portal frame 401.

As shown in the FIGS. 2-6, the joint device of the tire forming machine comprises a joint device connection frame 101, a composite part laminating device 201, and a cord fabric stitching device 301.

The joint device connection frame 101 is connected to the top portal frame 401 in a sliding manner. Joint device connection frame 101 axially slides along the portal frame 401 through the connection frame drive device, and is located above the vertical direction of the tire body drum 402.

As shown in FIG. 2, the joint device connection frame 101 comprises a main bracket 102 and lateral connection frame 103, wherein the main bracket 102 is arranged in parallel to the portal frame 401. The lateral connection frame 103 is connected with the main bracket 102 and used for carrying the composite part laminating device 201 and the cord fabric stitching device 301.

The connection frame drive device comprises first cylinders 105 arranged on the main frame 102, and the output shafts of the first cylinders 105 are connected to the portal frame 401. The first cylinder 105 can axially push the main frame 102 along the portal frame 401, so as to simultaneously move and locate the composite part laminating device 201 and the cord fabric stitching device 301 carried on the lateral connection frame 103 above the vertical direction of the tire body drum 402.

A plurality of slide frames 106 are connected to two sides of the main bracket 102. Slide blocks 107 arranged at the inner sides of the slide frames 106 are meshed with the slide rails 400 on the portal frame 401.

Second cylinders 108 connect and longitudinally push the lateral connection frame 103 in a reciprocating manner, and two pairs of hydraulic buffers 109 limit the longitudinal reciprocating displacement distance of the lateral connection frame 103. The hydraulic buffers 109 are arranged at the side parts of the main bracket 102.

The composite part laminating device 201 is carried on the lateral connection frame 103 of the joint device connection frame 101 through a composite part frame body 202.

The composite part frame body 201 comprises an axial laminating drive device and a vertical laminating drive device for controlling and driving the compression roller component 200 to be located on a composite workstation on the tire body drum 402, thus achieving the laminating operation.

The compression roller component 200 is used for carrying out the laminating operation on the inside liner and the tire sides for forming the tire billet.

As shown in FIG. 4, the axial stitching drive device comprises a first motor 203, which is arranged on the composite part frame body 202. The output shaft of the first motor 203 is connected with the first synchronous pulley 205 on the first synchronous belt 204, which is transversely arranged along the composite part frame body 202. The first synchronous belt 204 is also connected with a connection plate 206 for installing the compression roller component 200.

The vertical laminating drive device comprises a pair of third cylinders 207, which are arranged between the lateral connection frame 103 and the composite part frame body 202, and used for pushing and pulling the composite part frame body 202 along the vertical direction in the reciprocating manner.

As shown in FIG. 6, the cord fabric stitching device 301 is carried on the lateral connection frame 103 of the joint device connection frame 101 through the main stitching bracket 302.

The cord fabric stitching device 301 comprises an axial stitching drive device and a vertical stitching drive device for controlling and driving a stitching wheel component 300. Stitching wheel component 300 is located on a stitching workstation on the tire body drum 402 and performs the joint stitching operation.

The stitching wheel component 300 is used to carry out joint stitching aiming at the cord fabric.

The axial stitching drive device comprises a second motor 303, which is arranged on the main stitching bracket 302. The output shaft of the second motor 303 is connected to a second synchronous pulley 304 sleeved on the second synchronous belt 305, the second synchronous belt 305 is also connected with a third synchronous belt 307 arranged on the screw 306, which is transversely arranged along the main stitching bracket 302.

The stitching wheel component 300 is arranged on a pair of movable brackets 308, which are connected with the nut 309 sleeved on the screw 306.

The vertical stitching drive device comprises a pair of fourth cylinders (310) which are arranged on the movable brackets 308 and connected with the stitching wheel component 300.

As shown in FIGS. 1 to 6, the joint treatment method of the tire forming machine comprises the steps as follows: the compression roller component 200 is adopted to carry out the laminating operation on the inside liner and the tire side rubber attached to the tire body drum 402, the stitching wheel component 300 is adopted to carry out the joint stitching operation on the subsequently attached tire body cord fabric.

The joint device connection frame 101, connected to the top portal frame 401 in a sliding manner, axially slides along the portal frame 401 and is located above the vertical direction of the tire body drum 402.

The composite part laminating device 201 with the compression roller component 200 is carried on the joint device connection frame 101. The compression roller component 200 is located on the composite workstation on the tire body drum 402 along the axial direction and the vertical direction of the joint device connection frame 101.

The cord fabric stitching device 301 with the stitching wheel component 300 is carried on the joint device connection frame 101, and the stitching wheel component 300 is located on the stitching workstation on the tire body drum 402 along the axial direction and the vertical direction of the joint device connection frame 101.

A pair of second cylinders 108 for longitudinally pushing the lateral connection frame 103 in the reciprocating manner is arranged at the side part of the main bracket 102 of the joint device connection frame 101.

The composite part laminating device 201 and the cord fabric stitching device 301 are alternatively located on the vertical center line of the tire body drum 402.

In addition, two pairs of hydraulic buffers 109 are arranged at the side parts of the main bracket 102 of the joint device connection frame 101 to limit the displacement distances of the composite part laminating device 201 and the cord fabric stitching device 301 along the longitudinal direction.

The joint treatment method mainly comprises the implementation steps as follows:

The joint device connection frame 101 slides along the axial direction of the portal frame 401 and is located above the vertical direction of the tire body drum 402.

The composite part laminating device 201 is arranged on the vertical center line of the tire body drum 402; the compression roller component 200 descends to the composite workstation at one side end of the tire body drum 402 along the vertical direction, and moves to the other side end of the tire body drum 402 along the axial direction, so as to finish the laminating operation on the inside liner and the tire side rubber.

The compression roller component 200 ascends to the initial position along the vertical direction.

The second cylinder 108 pushes the lateral connection frame 103 to longitudinally move, so as to locate the cord fabric stitching device 301 on the vertical center line of the tire body drum 402.

The stitching wheel component 300 descends to the stitching workstation of the tire body drum 402 along the vertical direction and moves in the reciprocating manner along the axial direction of the tire body drum 402, so as to finish the joint stitching operation on the cord fabric of the tire body.

The stitching wheel component 300 ascends to the initial position along the vertical direction.

The joint device connection frame 101 reversely slides to the initial position along the axial direction of the top portal frame 401.

The second cylinder 108 reversely pushes the lateral connection frame 103 along the longitudinal direction, so as to enable the composite part laminating device 201 and the cord fabric stitching device 301 to slide to the initial positions.

As can be seen, the overall joint device is compact in structure, and does not occupy a large surface area. Thus, accidents caused by collision of the operator and the equipment can be effectively avoided.

As will be known to those skilled in the art, the joint device connection frame achieves axial sliding and locating; the composite part laminating device controls and drives the compression roller component to be located to the composite workstation. There may be a plurality of drive and guide mechanisms corresponding to the composite part laminating device for controlling and driving the compression roller component to be located on the composition workstation and the cord fabric stitching device for controlling and driving the stitching wheel component to be located on the stitching workstation. For example, drive devices such as a cylinder, a gear motor, a cylinder and the like are adopted, and guide mechanisms in the transmission processes of screw-nut, lead screw-nut, synchronous belt-synchronous pulley, gear-rack and the like are adopted.

The improved joint device connection frame comprises a main bracket, which is arranged in parallel to the portal frame; and a lateral connection frame, which is connected with the main bracket and used for carrying the composite part laminating device and the cord fabric stitching device.

The drive device applied to the joint device connection frame comprises a first cylinder which is connected between the joint device connection frame and the portal frame and used for pushing the joint device connection frame along the axial direction of the portal frame. A plurality of slide frames are connected to two sides of the main bracket; and slide blocks arranged at the inner sides of the slide frames are meshed with slide rails on the portal frame.

In the joint device connection frame, the first cylinder is a drive device for achieving axial sliding and locating along the portal frame while the slide frames achieve sliding guide by virtue of the slide blocks and the slide rails, so as to improve the smoothness of the joint device connection frame in the overall sliding process.

The main bracket provides a bearing platform through which the composite part laminating device and the cord fabric stitching device axially slide from the initial positions, and are located above the vertical direction of the tire body drum.

The composite part laminating device and the cord fabric stitching device are successively carried out and carried on the same joint device connection frame, and the problem of switching between two execution mechanisms and two operation workstations must be solved. The improvement scheme can be adopted as follows: a second cylinder for connecting and longitudinally pushing the lateral connection frame in a reciprocating manner is arranged on the side part of the main bracket. The composite part laminating device and the cord fabric stitching device can be orderly moved and located above the vertical center line of the tire body drum by controlling the stroke and the advance direction of the second cylinder. The composite part laminating device and the cord fabric stitching device are driven to advance to the operation workstations by respective axial drive device and the vertical drive device, so as to finish respective laminating operation and stitching operation.

In order to further improve the locating accuracy of the move strokes of the composite part laminating device and the cord fabric stitching device, the refining measures can be adopted as follows: two pairs of hydraulic buffers for limiting the longitudinal reciprocating displacement distance of the lateral connection frame can be arranged at the side part of the main bracket.

When the composite part laminating device or the cord fabric stitching device is respectively pushed to above the operation workstation on the tire body drum by the lateral connection frame, the lateral connection frame can be limited and buffered through the hydraulic buffers. The locating accuracy of the composite part laminating device or the cord fabric stitching device can be correspondingly improved by improving the mechanical manufacturing accuracy between the portal frame, the main bracket and the lateral connection frame.

The composite part frame body is arranged on the lateral connection frame of the joint device connection frame. The axial laminating drive device comprises a first motor arranged on the composite part frame body. An output shaft of the first motor is connected with a first synchronous pulley on a first synchronous belt which is transversely arranged along the composite part frame body, and the first synchronous belt is also connected with a connection plate for installing the compression roller component.

The vertical laminating drive device comprises a pair of third cylinders, which is arranged between the lateral connection frame and the composite part frame body, and used for pushing and pulling the composite part frame body in the reciprocating manner along the vertical direction.

The cord fabric stitching device is improved as follows. A main stitching bracket is arranged on the lateral connection frame of the joint device connection frame. The axial stitching drive device comprises a second motor, which is arranged on the main stitching bracket. The output shaft of the second motor is connected with a second synchronous pulley sleeved on a second synchronous belt. The second synchronous belt is also connected with a third synchronous pulley on a screw, which is transversely arranged along the main stitching bracket. The stitching wheel component is arranged on a pair of movable brackets; the movable brackets are connected with a nut sleeved on the screw. The vertical stitching drive device comprises a pair of fourth cylinders, which is arranged on the movable brackets and connected with the stitching wheel component.

Based on the structure improvement aiming at the joint device for the tire forming machine, the joint treatment method is also simultaneously achieved by the invention as follows.

The compression roller component is adopted to carry out the laminating operation on the inside liner and the tire side rubber attached to the tire body drum. The stitching wheel component is adopted to carry out the joint stitching operation on the subsequently attached tire body cord fabric.

Compared with the prior art, the joint device connection frame is connected to the top portal frame in a sliding manner, axially slides along the portal frame and is located above the vertical direction of the tire body drum. The composite part laminating device with the compression roller component is carried on the joint device connection frame. The compression roller component is located on the composite workstation on the tire body drum along the axial direction and the vertical direction of the joint device connection frame. The cord fabric stitching device with the stitching wheel component is carried on the joint device connection frame, and the stitching wheel component is located on the stitching workstation on the tire body drum along the axial direction and the vertical direction of the joint device connection frame.

In order to achieve switching of operation workstations between the composite laminating device and the cord fabric stitching device, a pair of second cylinder for longitudinally pushing the lateral connection frame in the reciprocating manner is arranged at the side part of the main bracket of the joint device connection frame.

The composite part laminating device and the cord fabric stitching device are alternatively located on the vertical center line of the tire body drum.

In order to improve the switching accuracy of the operation workstations between the composite part laminating device and the cord fabric stitching device, two pairs of hydraulic buffers are arranged at the side parts of the main bracket of the joint device connection frame to limit the displacement distances of the composite part laminating device and the cord fabric stitching device along the longitudinal direction.

By combination of the improvements of the joint treatment method, the joint treatment method comprises a joint device connection frame that slides along the axial direction of the portal frame and is located above the vertical direction of the tire body drum. The composite part laminating device is arranged on the vertical center line of the tire body drum. The compression roller component descends to the composite workstation at one side end of the tire body drum along the vertical direction, and moves to the other side end of the tire body drum along the axial direction, so as to finish the laminating operation on the inside liner and the tire side rubber. The compression roller component ascends to the initial position along the vertical direction. The second cylinder pushes the lateral connection frame to longitudinally move, so as to locate the cord fabric stitching device on the vertical center line of the tire body drum. The stitching wheel component descends to the stitching workstation of the tire body drum along the vertical direction and moves in the reciprocating manner along the axial direction of the tire body drum, so as to finish the joint stitching operation on the tire body cord fabric. The stitching wheel component ascends to the initial position along the vertical direction. The joint device connection frame reversely slides to the initial position along the axial direction of the top portal frame. The second cylinder reversely pushes the lateral connection frame along the longitudinal direction, so as to enable the composite part laminating device and the cord fabric stitching device to slide to the initial positions.

Thus, the joint device for the tire forming machine and the joint treatment method thereof have the following advantages.

The composite part laminating device and the cord fabric stitching device are integrally arranged on a same connection frame, so that the quantity and required installation space of the related components of the forming machine are simplified on the whole, clearing of the related ground conveying components is facilitated, control and auxiliary operations of the operator in the tire billet manufacturing process are facilitated, and the accident caused by collision of the operator and the equipment is avoided.

The laminating device and the stitching device carry out calibrating and centering on the basis of the same locating device by virtue of the same connection frame, and the centering accuracy is high in comparison with the operation workstation of the tire body drum.

Two operation flows of laminating of the composite part and stitching of the tire body cord fabric can be integrated, and shortening of the operation time and improvement of the production efficiency of the single tire billet are facilitated.

Pipeline pavement of ground equipments can be simplified, and overall installation, debugging and inspection of the forming machine by the operator are facilitated.

It will be apparent to those skilled in the art that various modification and variations can be made in the tire-forming machine connector apparatus and connector handling method of the present invention without departing from the spirit or scope of the present invention. Thus, it is intended that the present invention covers the modifications and variations of the invention provided they come within the scope of the applied claims and their equivalents.

1. A joint device for a tire forming machine, comprising a compression roller component configured to laminate an inside liner and tire sides for forming a tire billet, and a stitching wheel component configured joint stitch cord fabric, the joint device comprising:
a joint device connection frame connected to a top portal frame in a sliding manner, configured to axially slide along the portal frame through a connection frame drive device, and located above the vertical direction of a tire body drum;
a composite part laminating device carried on the joint device connection frame through a composite part frame body, comprising an axial laminating drive device and a vertical laminating drive device configured to control and drive the compression roller component a composite workstation on the tire body drum; and
a cord fabric stitching device carried on the joint device connection frame through a main stitching bracket comprising an axial stitching drive device and a vertical stitching drive device configured to control and drive a stitching wheel component on a stitching workstation on the tire body drum.

2. The joint device for the tire forming machine according to claim 1, wherein the joint device connection frame comprises a main bracket and a lateral connection frame; the main bracket is arranged in parallel to the portal frame;
the lateral connection frame being connected to the main bracket (102) and configured to carry the composite part laminating device and the cord fabric stitching device;
the connection frame drive device comprises a first cylinder arranged between the joint device connection frame and the portal frame, configured to axially push the joint device connection frame along the portal frame; and
a plurality of slide frames connected to two sides of the main bracket, slide blocks arranged at the inner sides of the slide frames are meshed with slide rails on the portal frame.

3. The joint device for the tire forming machine according to claim 2, further comprising a second cylinder, on the side of the main bracket, configured to connect and longitudinally push the lateral connection frame in a reciprocating manner.

4. The joint device for the tire forming machine according to claim 3, further comprising two pairs of hydraulic buffer, at the side of the main bracket, configured to limit the longitudinal reciprocating motion distance of the lateral connection frame.

5. The joint device for the tire forming machine according to claim 2, wherein a composite part frame body of the composite part laminating device is arranged on the lateral connection frame of the joint device connection frame; and wherein
an axial laminating drive device comprises:
a first motor arranged on the composite part frame body;
an output shaft of the first motor is connected with a first synchronous pulley on a first synchronous belt, which is transversely arranged along the composite part frame body; the first synchronous belt also being connected with a connection plate for installing the compression roller component; and
the vertical laminating drive device comprises a pair of third cylinders arranged between the lateral connection frame and the composite part frame body and configured to push and pull the composite part frame body in a reciprocating manner along a vertical direction.

6. The joint device for the tire forming machine according to claim 5, wherein the main stitching bracket of the cord fabric stitching device is arranged on the lateral connection frame of the joint device connection frame;
the axial stitching drive device comprises a second motor arranged on the main stitching bracket;
the output shaft of the second motor is connected with a second synchronous pulley sleeved on a second synchronous belt, the second synchronous belt connected with a third synchronous pulley on a screw, which is transversely arranged along the main stitching bracket;
the stitching wheel component arranged on a pair of movable brackets, the movable brackets connected with a nut sleeved on the screw; and
the vertical stitching drive device comprises a pair of fourth cylinders, arranged on the movable brackets and connected with the stitching wheel component.

7. A joint treatment method achieved by the joint device for the tire forming machine according to claim 1, comprising:
laminating, by the compression roller component, on the inside liner and the tire side rubber attached to the tire body drum;
joint stitching, by the stitching wheel component, on the subsequently attached tire body cord fabric; wherein:
the joint device connection frame connected to the top portal frame in a sliding manner, axially slides along the portal frame and is located above the vertical direction of the tire body drum;
the composite part laminating device with the compression roller component is carried on the joint device connection frame, the compression roller component is located on the composite workstation on the tire body drum along the axial direction and the vertical direction of the joint device connection frame; and
the cord fabric stitching device with the stitching wheel component is carried on the joint device connection frame, and the stitching wheel component is located on the stitching workstation on the tire body drum along the axial direction and the vertical direction of the joint device connection frame.

8. The joint treatment method for the tire forming machine according to claim 7, wherein a pair of second cylinders for longitudinally pushing the lateral connection frame in the reciprocating manner is arranged at a side part of the main bracket of the joint device connection frame; and
the composite part laminating device and the cord fabric stitching device are alternatively located on the vertical center line of the tire body drum.

9. The joint treatment method for the tire forming machine according to claim 8, wherein two pairs of hydraulic buffers are arranged at the side part of the main bracket of the joint device connection frame to limit the displacement distances of the composite part laminating device and the cord fabric stitching device along the longitudinal direction.

10. The joint treatment method for the tire forming machine according to claim 9, further comprising:
sliding, by the joint device connection frame, along the axial direction of the portal frame, wherein the joint device connection frame is located above a vertical direction of the tire body drum; and the composite part laminating device is arranged on the vertical center line of the tire body drum;
descending, by the compression roller component, to the composite workstation at one side end of the tire body drum, along the vertical direction, and moving to the other side end of the tire body drum along the axial direction, so as to finish the laminating operation on the inside liner and the tire side rubber;
ascending, by the compression roller component, to the initial position along the vertical direction;
pushing, by the second cylinder, the lateral connection frame to longitudinally move, so as to locate the cord fabric stitching device on the vertical center line of the tire body drum;
descending, by the stitching wheel component to the stitching workstation of the tire body drum along the vertical direction, and moving in a reciprocating manner along the axial direction of the tire body drum, so as to finish the joint stitching operation on the tire body cord fabric;
ascending, by the stitching wheel component to the initial position along the vertical direction;
reversely sliding, by the joint device connection frame to the initial position along the axial direction of the top portal frame; and
reversely pushing, by the second cylinder to the lateral connection frame along the longitudinal direction, so as to enable the composite part laminating device and the cord fabric stitching device to slide to the initial positions.
